(19) United States
(12) Patent Application Publication
(10) Pub. No.: US 2024/0214605 A1
(43) Pub. Date: Jun. 27, 2024

(54) TRANSMITTER SYSTEM, RECEIVER SYSTEM, AND METHOD FOR PROCESSING VIDEO

(71) Applicant: GUANGDONG OPPO MOBILE TELECOMMUNICATIONS CORP., LTD., Dongguan (CN)

(72) Inventors: Marek DOMANSKI, Poznan (PL); Tomasz GRAJEK, Poznan (PL); Adam GRZELKA, Poznan (PL); Slawomir MACKOWIAK, Poznan (PL); Slawomir ROZEK, Poznan (PL); Olgierd STANKIEWICZ, Poznan (PL); Jakub STANKOWSKI, Poznan (PL)

(21) Appl. No.: 18/600,758

(22) Filed: Mar. 10, 2024

Related U.S. Application Data
(63) Continuation of application No. PCT/CN22/77141, filed on Feb. 21, 2022.

(30) Foreign Application Priority Data
Sep. 13, 2021 (EP) 21461590.8

(51) Int. Cl. H04N 19/537; G06T 7/11; G06T 7/194; G06V 10/77; G06V 20/58; H04N 19/25

(52) U.S. Cl. CPC H04N 19/537; G06T 7/11; G06T 7/194; G06V 10/7715; G06V 20/582; H04N 19/25; G06T 2207/10016

(57) ABSTRACT

A transmitter system for processing a video includes: an object recognition component configured to identify one or more objects in the video and extract one or more features associated with the one or more objects; a video processing component configured to process each frame of the video by removing the one or more objects; a video encoding component configured to encode the processed video; and a transmitting component configured to transmit the encoded video and the extracted features of the one or more objects.

### CROSS-REFERENCE TO RELATED APPLICATION(S)

This application is a continuation of International Application No. PCT/CN2022/077141, filed Feb. 21, 2022, which claims to priority to European Patent Application No. 21461590.8, filed Sep. 13, 2021, the entire disclosures of which are hereby incorporated by reference.

### TECHNICAL FIELD

This application relates to video coding and more particularly to a transmitter system, a receiver system, and a method for processing a video.

### BACKGROUND

Video compression has been used for transmitting video data. Higher compression rates help ease the required resources for transmission but can result in loss of video qualities. For images observed by human beings, loss of image quality can affect aesthetic factors (e.g., looks good or not) of a video and accordingly deteriorate user experience. However, for images to be recognized by machines (e.g., self-driving vehicles), the context of the images is more important than the aesthetic factors of the video. Recent development of Video Coding for Machines (VCM) can be found in ISO/IEC JTC 1/SC 29/WG 2 N18 “Use cases and requirements for Video Coding for Machines.” To reduce transmission time and consumption of transmission resources for video data for machines, it is desirable to have an improved system and method to effectively encode and decode the video data for machines.

### SUMMARY

In a first aspect, a transmitter system for processing a video is provided. The transmitter includes an object recognition component configured to identify one or more objects in the video and extract one or more features associated with the one or more objects; a video processing component configured to process each frame of the video by removing the one or more objects; a video encoding component configured to encode the processed video; and a transmitting component configured to transmit the encoded video and the extracted features of the one or more objects.

In a second aspect, a receiver system for processing a video is provided. The receiver includes a receiving component configured to receive an encoded video and one or more extracted features, wherein one or more objects of the encoded video have been removed, and wherein the one or more extracted features are associated with the one or more objects; a video decoding component configured to decode the encoded video; an object reconstruction component and configured to generate an image based on the extracted features; and a video merging component configured to combine the image based on the extracted features with the decoded video.

In a third aspect, a method for processing a video is provided. The method includes: identifying one or more objects in the video; extracting features associated with the identified objects; processing images corresponding to the identified objects in each frame of the video; generating descriptors corresponding to the extracted features; compressing the generated descriptors; encoding the video with the processed images; and transmitting the encoded video and the encoded descriptors.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a wireless communication system in accordance with one or more implementations of the present disclosure. In some embodiments, the present technology can also be implemented in a wired communication system.

FIG. 2 is a schematic diagram illustrating a system in accordance with one or more implementations of the present disclosure.

FIG. 3 is a schematic diagram illustrating a transmitter in accordance with one or more implementations of the present disclosure.

FIG. 4 is a schematic diagram illustrating a receiver in accordance with one or more implementations of the present disclosure.

FIG. 5 is a schematic diagram illustrating image processing of an object in accordance with one or more implementations of the present disclosure.

FIGS. 6A, 6B, 6C, and 6D are examples of images processed by the methods in the present disclosure.

FIGS. 7A and 7B are examples of images processed by the methods in the present disclosure.

FIGS. 8A and 8B are examples of images processed by the methods in the present disclosure.

FIG. 9 is flowchart illustrating a method in accordance with one or more implementations of the present disclosure.

FIG. 10 is a schematic block diagram of a terminal device in accordance with one or more implementations of the present disclosure.

### DETAILED DESCRIPTION

The present disclosure provides apparatuses and methods for processing video data for machines. In some embodiments, the machines can include self-driving vehicles, robots, aircrafts, and/or other suitable devices or computing systems that are capable of video data processing and analysis, e.g., using artificial intelligence. More particularly, the present disclosure provides (i) a transmitter configured to encode or compress video data based on identified objects and/or features of the video, and (ii) a receiver configured to decode or decompress the video data encoded or compressed by the foregoing transmitter.

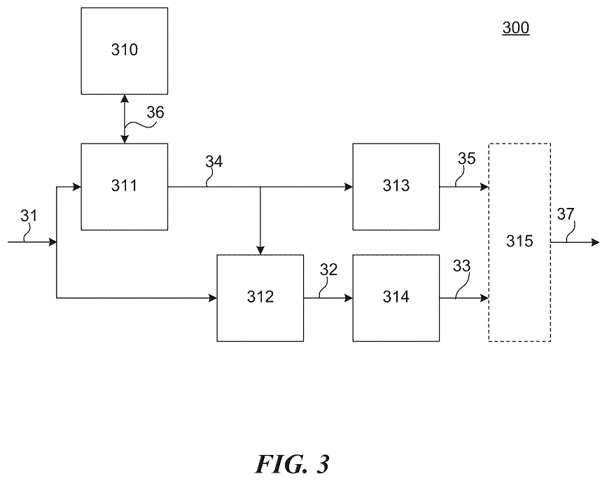

When encoding a video, the transmitter can (i) identify one or more objects (e.g., a traffic sign, a road indicator, logos, tables, other suitable areas/fields that provide textual and/or numerical information, etc.) in the video; (ii) extract features (e.g., texts, numbers, and their corresponding colors, fonts, sizes, locations, etc.) associated with the identified objects; (iii) monitor and/or track the identified objects to determine or predict their moving directions and/or trajectories; (iv) processing images corresponding to the identified objects in each frame of the video (e.g., use a representative color to fill the whole area that the identified object occupies, so as to significantly reduce the resolution of that area); (v) encode (or compress) the video with the processed images; and (vi) transmit the encoded (or compressed) video and the extracted features via a network (e.g., in a bitstream). Embodiments of the transmitter are discussed in detail with reference to FIG. 3.

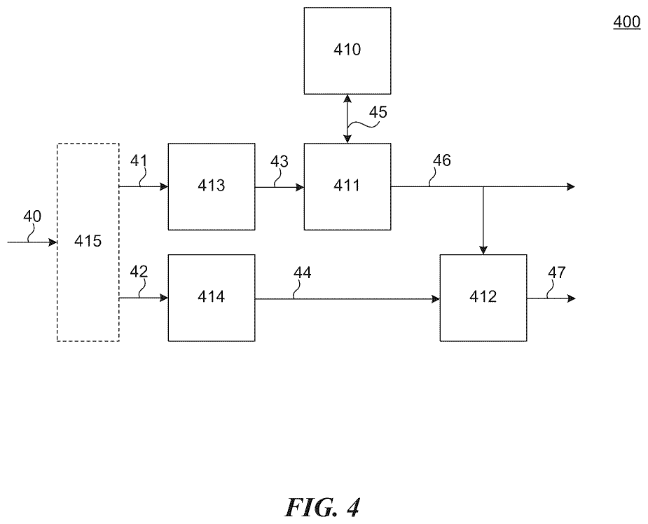

The present disclosure also provides a receiver configured to decode the encoded video. In some embodiments, the receiver can (a) receive an encoded video via a network; (b) decode the encoded video based on identified objects and their corresponding features; (c) generate a decoded video with the identified objects. Embodiments of the receiver are discussed in detail with reference to FIG. 4.

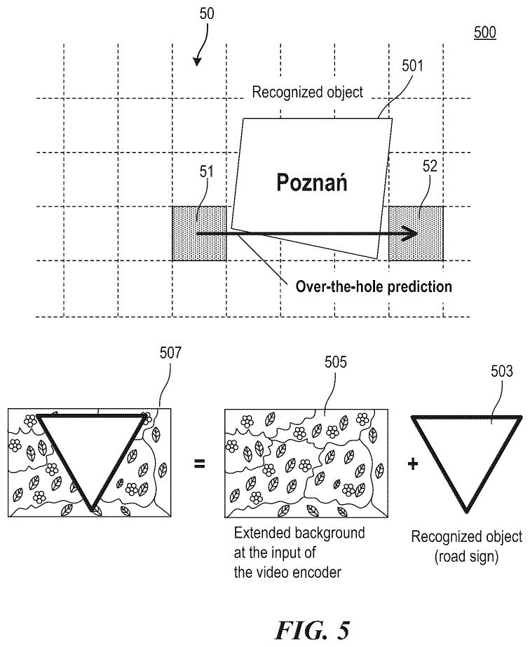

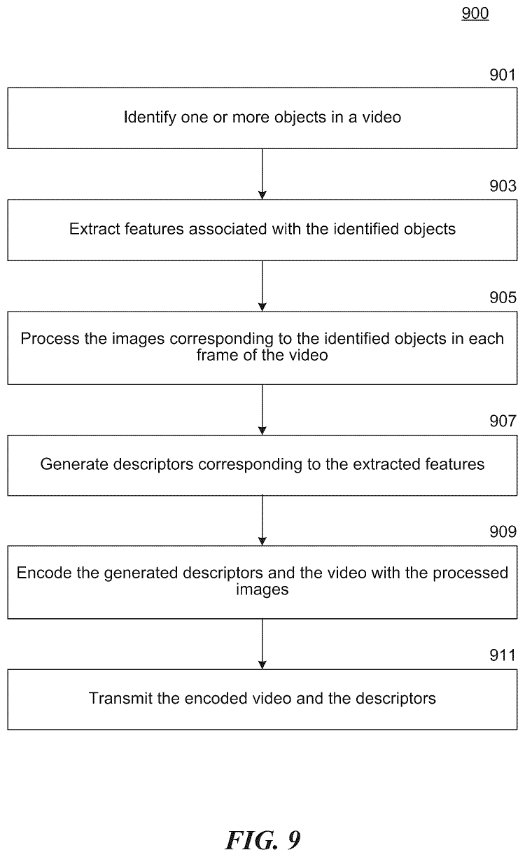

One aspect of the present disclosure is to provide methods for processing a video with objects. The method includes, for example, (1) identifying one or more objects in the video; (2) extracting features associated with the identified objects; (3) determining locations, moving directions, and/or trajectories of the identified objects; (4) processing the images corresponding to the identified objects in each frame of the video; (5) generating descriptors corresponding to the extracted features; (6) compressing the generated descriptors; (7) encoding the video with the processed images (e.g., separately encoding the processed image and the rest of the video); (8) transmitting the encoded video and the compressed descriptors (e.g., by multiplexed bitstreams). In some embodiments, the method can further include (9) receiving the encoded video and the compressed descriptors via a network; (10) decompressing the compressed descriptors; and (11) decoding the encoded video based on the decompressed descriptors. Embodiments of the method are discussed in detail with reference to FIGS. 5 and 9. In some embodiments, the objects can include signs, advertisement, direction/traffic signs, etc.

In some embodiments, the present method can be implemented by a tangible, non-transitory, computer-readable medium having processor instructions stored thereon that, when executed by one or more processors, cause the one or more processors to perform one or more aspects/features of the method described herein.

### Communications Environment

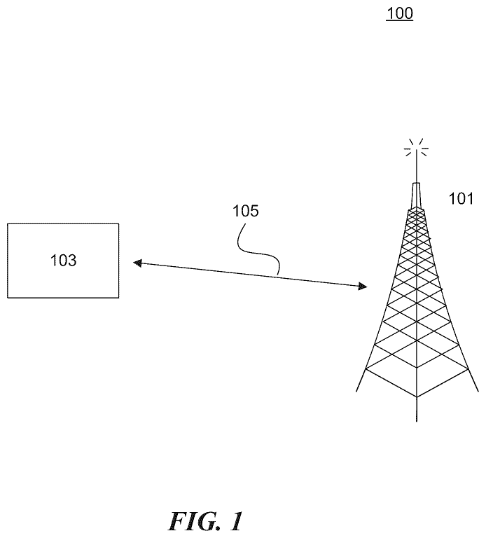

FIG. 1 illustrates a system 100 for implementing the methods of the present disclosure. As shown in FIG. 1, the system 100 includes a network device 101. Examples of the network device 101 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 101 can include a relay station, an access point, an in-vehicle device, a wearable device, and the like. The network device 101 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), a “vehicle-to-vehicle” (V2V) communication, a “vehicle-to infrastructure” (V2I) communications, or the like. A 5G system or network may be referred to as a new radio (New Radio, NR) system or network.

As shown in FIG. 1, the system 100 also includes a terminal device 103. The terminal device 103 can be an end-user device configured to communicate with the network device 101. The terminal device 103 can be configured to wirelessly connect to the network device 101 (via, e.g., a wireless channel 105) according to one or more corresponding communication protocols/standards. The terminal device 103 may be mobile, fixed, wired, tethered, or untethered. The terminal device 103 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 103 include a modem, a cellular phone, a smart phone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an IoT device, a terminal device in a future 5G network, a terminal device in a future evolved PLMN, or the like.

For illustrative purposes, FIG. 1 illustrates only one network device 101 and one terminal device 103 in the wireless communications system 100. However, it is understood that, in some instances, the wireless communications system 100 can include additional/other devices, such as additional instances of the network device 101 and/or the terminal device 103, a network controller, a mobility management entity/devices, etc.

In some embodiments, the network device 101 can act as a transmitter described herein. Alternatively, in some embodiments, the network device 101 can act as a receiver described herein. Similarly, the terminal device 103 can act as a transmitter described herein. Alternatively, in some embodiments, the terminal device 103 can act as a receiver described herein.

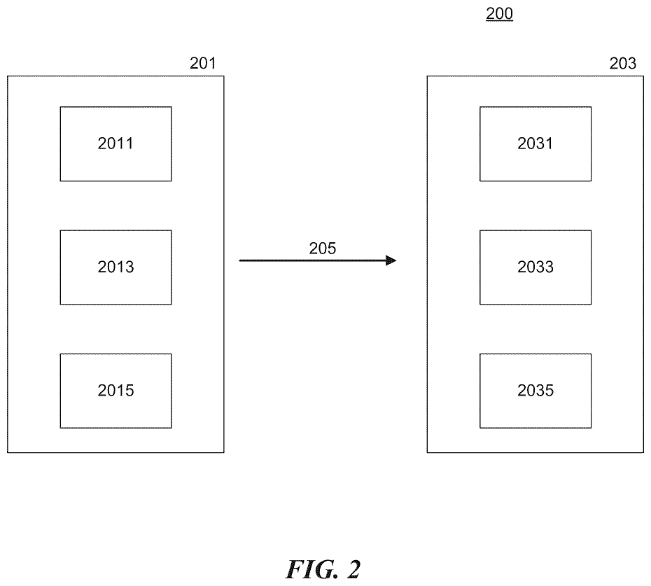

FIG. 2 is a schematic diagram illustrating a system 200 in accordance with one or more implementations of the present disclosure. The system 200 includes a transmitter 201 and a receiver 203. The transmitter 201 is configured to transmit encoded video data to the receiver 203 via a network 205. The transmitter 201 includes a processor 2011, a memory 2013, and an encoder 2015. In some embodiments, the transmitter 201 can be implemented as a chip (e.g., a system on chip, SoC). The processor 2011 is configured to implement the functions of the transmitter 201 and the components therein. The memory 2013 is configured to store data, instructions, and/or information associated with the transmitter 201. The encoder 2015 is configured to process and encode a video with one or more objects. In some embodiments, the encoder 2015 can (1) identify one or more objects in the video; (2) extract one or more features associated with the one or more objects; (3) process each frame of the video based on the one or more objects; (4) encode the processed video; and (5) transmit the encoded video and the extracted feature.

In some embodiments, the encoder 2015 can be used to process video data for machines, such as vehicles, aircrafts, ships, robots, other suitable devices or computing systems that are capable of video data processing and analysis, e.g., using artificial intelligence, etc. The encoder 2015 can first identify one or more objects in the video. Embodiments of the object can include, for example, a traffic sign, a road indicator, a company/business table (e.g., “CocaCola,” “McDonalds” signs, etc.), pictograms, logos, other suitable areas/fields that provide textual and/or numerical information, etc. In some embodiments, the object can be defined by a system operator (e.g., a particular shape, in a specific color, with certain textual features, etc.).

Once the object is identified, the encoder 2015 can extract one or more feature from the identified object. Examples of the extracted features include texts, numbers, and their corresponding colors, fonts, sizes, locations, etc. associated with the identified objects. For example, a traffic sign in a video can be identified as an object and the information “speed limit: 100 km/h” in the traffic sign can be the extracted feature. By separating the information carried by the traffic sign, the video including the traffic sign can be compressed in a higher ratio (which corresponds to a smaller data size for transmission), without worrying that doing so may result in the information become not recognizable due to the compression.

The encoder 2015 can further process the video by removing the images associated with the object in each frame of the video. In some embodiments, these images associated with the object can be replaced by a signal color (e.g., the same or similar to a surrounding image; a representative color, etc.) or a background image (e.g., a default background of a traffic sign). In some embodiments, these images can be left blank (to be generated by a decoder afterwards). The processed video (i.e., with the objects removed, replaced, or edited) can then be encoded (e.g., as a bitstream) for transmission.

In some embodiments, the encoder 2015 can be configured to track or monitor the identified objects such that it can determine or predict the locations, moving directions, and/or trajectories of the objects in the incoming frame. For example, the encoder 2015 can set a few locations (e.g., pixels) surrounding the objects as “check points” to track or monitor the possible location changes of the objects. By this arrangement, the encoder 2015 can effectively identify and manage the objects, without losing tracking of them. In some embodiments, information regarding the boundary of an object can be tracked and/or updated on a frame-by-frame basis.

The encoded video and the extracted feature can then be transmitted via the network 205. In some embodiments, the encoded video and the extracted feature can be transmitted in two bitstreams. In some embodiments, the encoded video and the extracted feature can be transmitted in the same bitstream.

As shown in FIG. 2, the receiver 203 receives the encoded video and then can “restore” the encoded video by encoding it and adding the extracted feature thereto. For example, in some embodiments, the objects can be modified and added according to corresponding descriptors (e.g., viewing direction, a size/shape of the object, etc.) The receiver 203 includes a processor 2031, a memory 2033, and a decoder 2035. In some embodiments, the receiver 203 can be implemented as a chip (e.g., a system on chip, SoC). The processor 2031 is configured to implement the functions of the receiver 203 and the components therein. The memory 2033 is configured to store data, instructions, and/or information associated with the receiver 203. The decoder 2035 is configured to decode the encoded video and restore the removed/replaced objects therein. In some embodiments, the decoder 2035 can perform functions in a “reverse” fashion as the encoder 2015 to restore the video. In some embodiments the decoder 2035 can further process the video for better image quality or generate video based on user preferences.

In some embodiments, the transmitter 201 and the receiver 203 can both include an object database for storing reference object information (e.g., types of the objects; sample objects for comparison, etc.) for identifying the one or more objects. In some embodiments, the information stored in the object database can be trained by a machine learning process so as to enhance the accuracy of identifying the objects.

In some embodiments, the extracted feature can be described in a descriptor. The descriptor is indicative of the textual (e.g., a table of texts; road names, etc.), numerical (e.g., numbers shown), locational (a relative location of the object; a moving direction, etc.), contextual (the object is adjacent to a building or a road), and/or graphical (e.g., color, size, shape, etc.) information of the extracted feature. The descriptor can be stored, e.g., fully or partially, in the object data database. For example, the descriptors (e.g., traffic signs) can be stored in the object data database, and only the parameters of the descriptors (e.g., their size, location and the parameters of an affine transformation defining their appearance) are transmitted.

In some embodiments, the encoding, decoding, compressing and decompressing processes described herein can include coding processes involving Advanced Video Coding (AVC), High Efficiency Video Coding (HEVC), Versatile Video Coding (VVC), Alliance for Open Media Video 1 (AV1) or any other suitable methods, protocols, or standards.

FIG. 3 is a schematic diagram illustrating a transmitter 300 in accordance with one or more implementations of the present disclosure. The transmitter 300 includes an object database 310, an object recognition component 311, a video processing component 312, a compressing component 313, a video encoder 314, and a bitstream multiplexer (or a transmitting component) 315. The foregoing components can be controlled or managed by a processor of the transmitter 300.

When an input video 31 comes into the transmitter 300, it can be directed to the object recognition component 311 and the video processing component 312. In some embodiments, the input video 31 can come first to the object recognition component 311 and then to the video processing component 312.

The object recognition component 311 is configured to recognize one or more objects in the video. As shown in FIG. 3, the object recognition component 311 is coupled to the object database 310. The object database 310 stores reference object information (e.g., types of the objects; sample objects for comparison, etc.) for identifying the one or more objects in a video. In some embodiments, the information stored in the object database 310 can be trained by a machine learning process so as to enhance the accuracy of identifying the objects. The object recognition component 311 can send a query and receive a query response 36 from the object database 310. The query response 36 can facilitate the object recognition component 311 to identify and/or determine one or more objects in the input video 31.

Once the one or more objects have been identified, one or more features associated with the one or more objects can be extracted. Examples of the extracted features include texts, numbers, and their corresponding colors, fonts, sizes, locations, etc. associated with the identified objects. One or more descriptors 34 can be generated based on the extracted features. The descriptors 34 are indicative of the foregoing features of the one or more objects (e.g., what the features are and where they are located, etc.). The descriptors 34 are sent to the video processing component 312 and the compressing component 313 for further process.

After the compressing component 313 receives the descriptors 34, the descriptors 34 are compressed so as to generate compressed descriptors 35. In some embodiments, the compression rate of the foregoing compression can be determined based on the content of the descriptors 34. The compressed descriptors 35 is then sent to the bitstream multiplexer 315 for further process.

After the video processing component 312 receives the descriptors 34, the input video is processed by removing the identified objects therein (e.g., based on the information provided by the descriptors 34). The video processing component 312 then generates a processed video 32 (with the identified objects removed). In some embodiments, the removed object can be replaced by a blank, a background color, a background image, or a suitable item with lower image resolution than the removed objects. Embodiments of the blank, the background color, and the background image are discussed in detail with reference to FIG. 5. The processed video 32 is then sent to the video encoder 314 for further process.

The video encoder 314 then encodes the processed video 32 by using a video coding scheme such as AVC, HEVC, VVC, AV1, or any other suitable methods, protocols, or standards. The video encoder 314 then generates an encoded video 33, which is sent to the bitstream multiplexer 315 for further process.

After receiving the encoded video 33 and the compressed descriptors 35, the bitstream multiplexer 315 can generate a multiplexed bitstream 37 for transmission. In some embodiments, the multiplexed bitstream 37 can include two bitstreams (i.e., one is for the encoded video 33; the other is for the compressed descriptors 35). In some embodiments, the multiplexed bitstream 37 can be a single bitstream. In some embodiments, the transmitter 300 can be implemented without the multiplexed bitstream 37.

FIG. 4 is a schematic diagram illustrating a receiver 400 in accordance with one or more implementations of the present disclosure. The receiver 400 includes a bitstream demultiplexer (or a receiving component) 415, an object description decoder 413, an object reconstruction component 411, an object database 410, a video decoder 414, and a video merging component 412.

The bitstream demultiplexer 415 receives and multiplexes a multiplexed compressed bitstream 40. Accordingly, the bitstream demultiplexer 415 can generate a compressed descriptors 41 and an encoded video 42. The encoded video 42 is sent to the video decoder 414. The video decoder 414 then decodes the encoded video 42 and generates decoded video 44 (with objects removed). The decoded video 44 is sent to the video merging component 412 for further process.

The compressed descriptors 41 is sent to the object description decoder 413. The object description decoder 413 can decode the compressed descriptors 41 and then generates descriptors 43. The descriptors 43 are indicative of one or more extracted features corresponding to one or more objects. The descriptors 43 are sent to the object reconstruction component 411 for further process.

The object reconstruction component 411 is coupled to the object database 410. The object database 410 stores reference object information (e.g., types of the objects; sample objects for comparison, etc.) for recognizing the one or more objects corresponding based on the descriptors 43. In some embodiments, the information stored in the object database 410 can be trained by a machine learning process so as to enhance the accuracy of identifying the objects. The object reconstruction component 411 can send a query and receive a query response 45 from the object database 410. The query response 45 can facilitate the object reconstruction component 411 to recognize the one or more objects indicated by the descriptors 43. Accordingly, the object reconstruction component 411 can generate reconstructed objects 46. The reconstructed objects 46 can be sent to the video merging component 412 for further process. In some embodiments, the reconstructed objects 46 can also be sent and used for reference or machine-vision/machine-learning studies.

After receiving the reconstructed objects 46 and the decoded video 44, the video merging component 412 merges the reconstructed objects 46 and the decoded video 44 and generates a decoded video with objects 47. The decoded video with objects 47 has a resolution suitable for human beings (as well as machines) to recognize the objects therein.

FIG. 5 is a schematic diagram illustrating image processing of an object 501 in accordance with one or more implementations of the present disclosure. As shown in FIG. 5, the object 501 is in an image 500, which includes multiple grids 50. When the object 501 is identified or recognized, the image 500 can be processed to remove the object 501 by performing an “over-the-hole” process. For example, during the “over-the-hole” process, the grids occupied by the object 501 can be removed. These grids can be replaced by a blank 503, a background image 505, or values interpolated by adjacent grids 51, 52. By this arrangement, the object 501 can be removed from the image 500 and an image 507 with object removed can be generated for process.

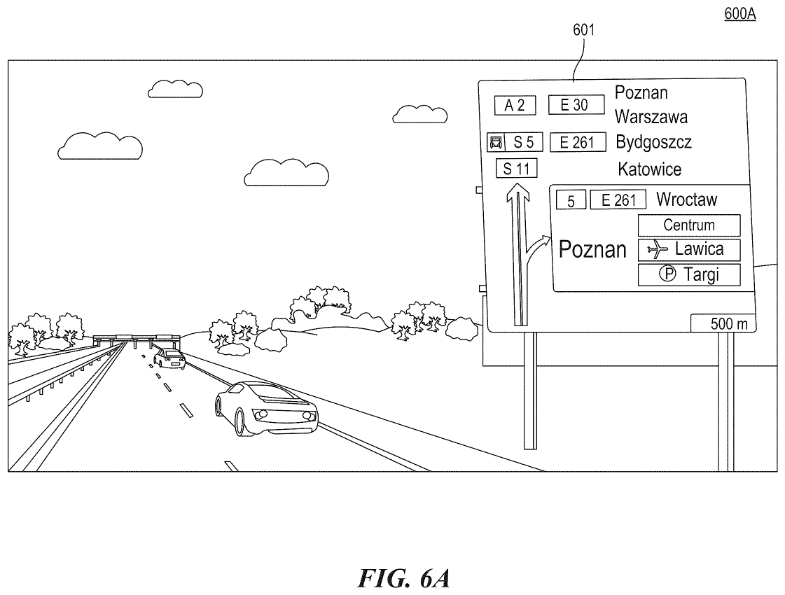

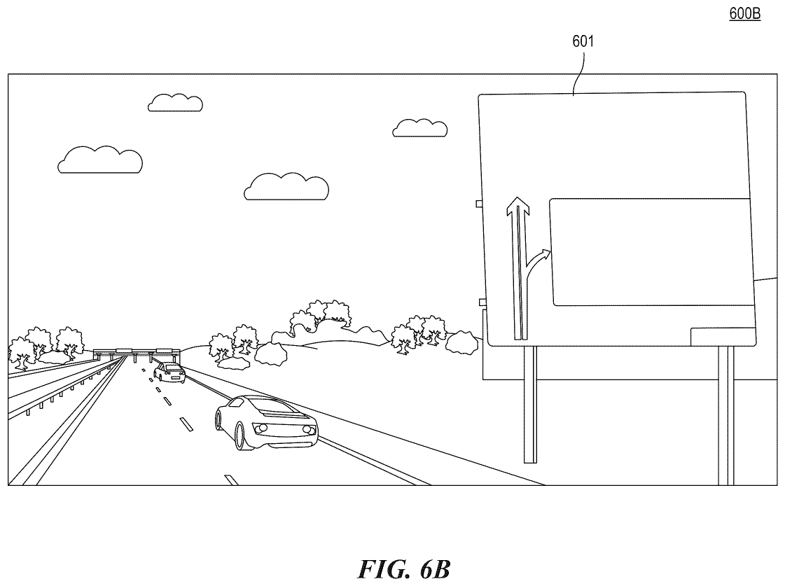

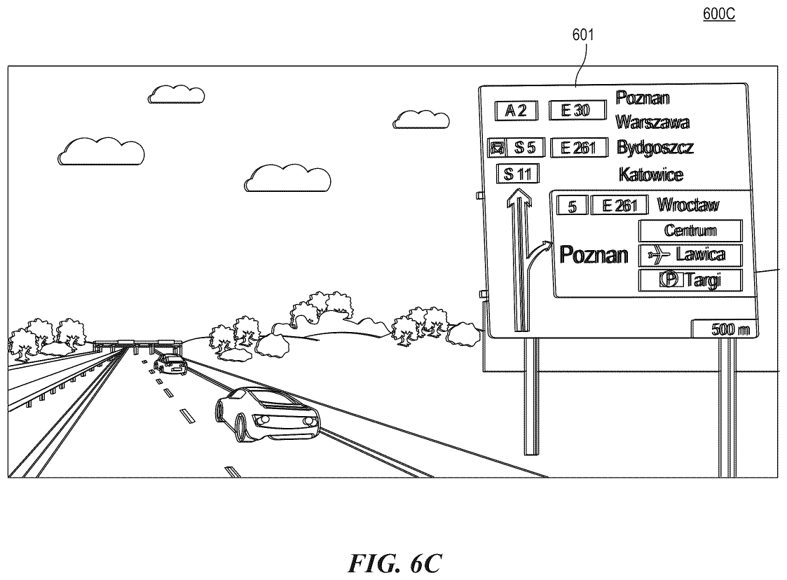

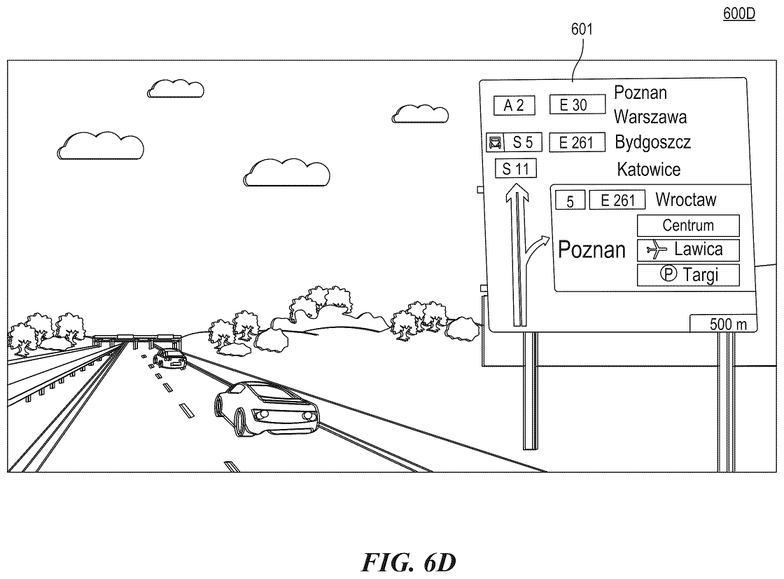

FIGS. 6A, 6B and 6C are examples of images processed by the methods in the present disclosure. FIG. 6A shows an original image 600A includes a traffic sign 601 (i.e., an object) therein. FIG. 6B shows a processed image 600B with the traffic sign 601 removed and replaced with background colors. The processed image 600B can be transmitted with a high image compression rate without concerns of losing information carried by the traffic sign 601. In some embodiment, the traffic sign 601 can only be “partially removed” by reducing its resolution, as shown in an processed image 600C of FIG. 6C. After transmission, the processed image 600B or 600C can be restored or “inpainted” as a restored image 600D shown in FIG. 6D.

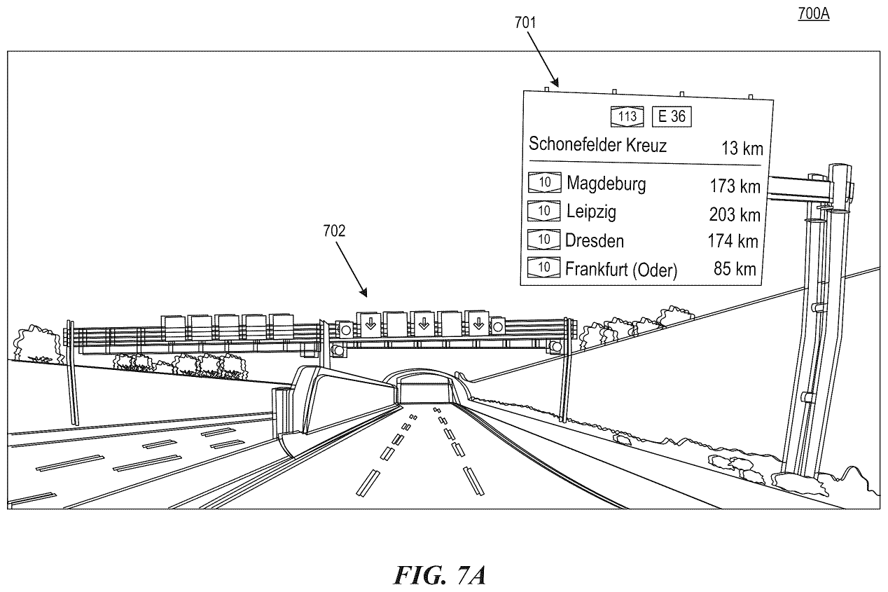

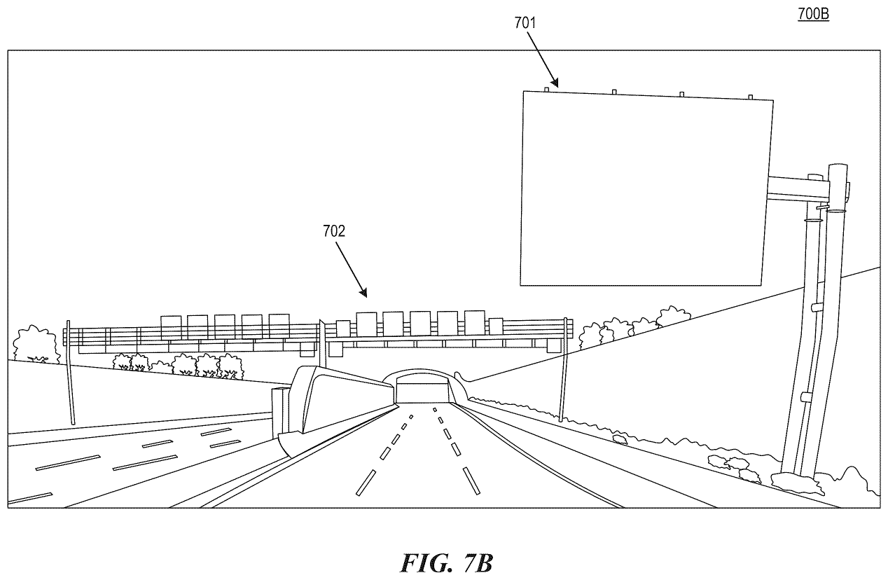

FIGS. 7A and 7B are examples of images processed by the methods in the present disclosure. In the embodiments illustrated in FIGS. 7A and 7B, an original image 700A includes two objects, a traffic sign 701 and a lane indicator 702. As shown in FIG. 7B, both objects can be removed as shown in a processed image 700B.

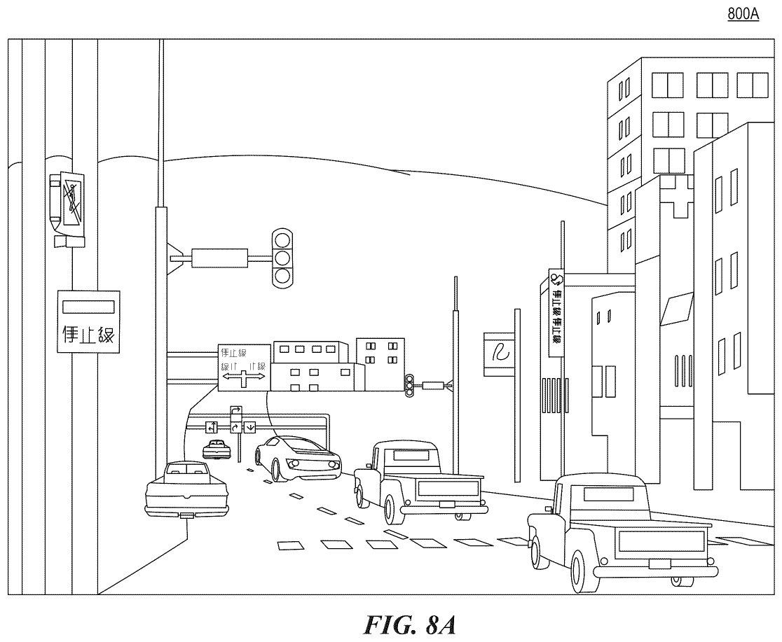

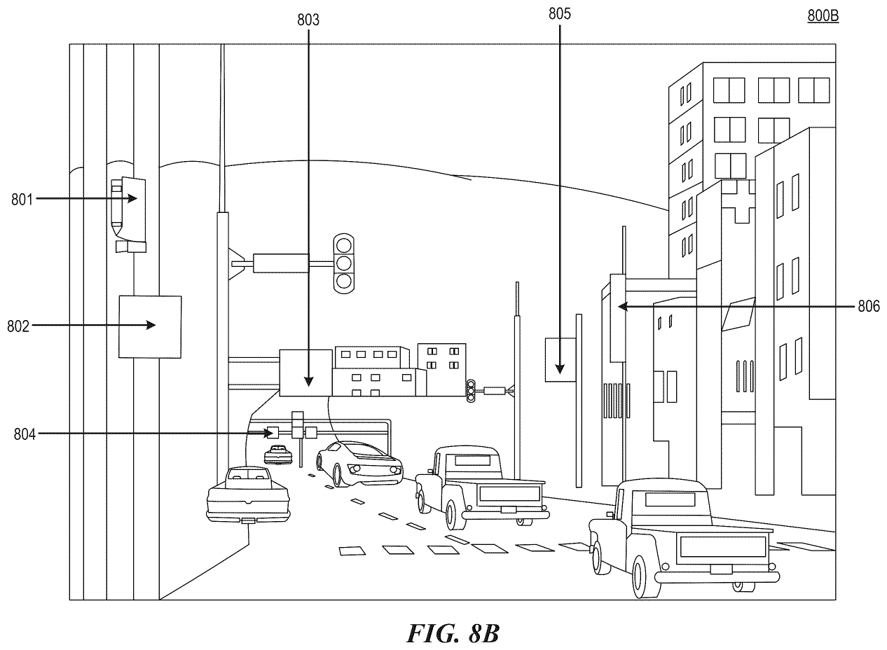

In some embodiments, there can be more than two objects in an image. In FIG. 8A, an original image 800A includes multiple potential objects. The present system and methods enable an operator to determine the criteria to identify objects and determine whether to process the images associated the objects. For example, as shown in FIG. 8B, six objects 801-806 are identified and processed. However, in other embodiments, the operator can determine only to process a portion of the identified objects (e.g., only process objects 801-804, but not objects 805, 806). The present system enables the operator to customize the object identification process (e.g., what type of object is to be identified) and determine whether to process certain type of objects.

FIG. 9 is flowchart illustrating a method 900 in accordance with one or more implementations of the present disclosure. The method 900 can be implemented by a system (the system 200), a transmitter (e.g., the transmitter 201 or 300), and/or a receiver (e.g., the receiver 203 or 400) to process a video.

At block 901, the method 900 starts by identifying one or more objects in the video. Embodiments of the object can include, for example, a traffic sign, a road indicator, other suitable areas/fields that provide textual and/or numerical information, etc. In some embodiments, the object can be defined by a system operator (e.g., a particular shape, in a specific color, with certain textual features, etc.).

The method 900 continues to extract features associated with the identified objects at block 903. Examples of the extracted features include texts, numbers, and their corresponding colors, fonts, sizes, locations, etc. associated with the identified objects. For example, a traffic sign in a video can be identified as an object and the information “speed limit: 100 km/h” in the traffic sign can be the extracted feature.

At block 905, the method 900 continues to process the images corresponding to the identified objects in each frame of the video. In some embodiments, the images can be processed by removing the objects therein (see, e.g., FIG. 5).

At block 907, the method 900 continues to generate descriptors corresponding to the extracted features. In some embodiments, the descriptor can be indicative of the textual (e.g., a table of texts; road names, etc.), numerical (e.g., numbers shown), locational (a relative location of the object; a moving direction, etc.), contextual (the object is adjacent to a building or a road), and/or graphical (e.g., color, size, shape, etc.) information of the extracted feature. The descriptor can be stored in the object data database.

At block 909, the method 900 continues to encode the generated descriptors and the video with the processed images.

At block 911, the method 900 continues to transmit the encoded video and the descriptors. In some embodiments, the descriptors can be compressed in a first scheme, whereas the video with the processed images can be encoded by a second scheme. In some embodiments, the first and second schemes can be the same. In some embodiments, the first and second schemes can be different. In some embodiments, the encoding, decoding, compressing and decompressing processes described herein can include coding processes involving Advanced Video Coding (AVC), High Efficiency Video Coding (HEVC), Versatile Video Coding (VVC), Alliance for Open Media Video 1 (AV1) or any other suitable methods, protocols, or standards.

In some embodiments, the encoded video and the descriptors can be multiplexed and transmitted in a single bitstream or two bitstreams. In some embodiments, the method 900 can further include receiving the encoded video and the compressed descriptors via a network; decompressing the compressed descriptors; and decoding the encoded video based on the decompressed descriptors.

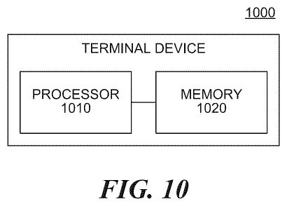

FIG. 10 is a schematic block diagram of a terminal device 1000 (e.g., an example of the terminal device 103 of FIG. 1) in accordance with one or more implementations of the present disclosure. As shown in FIG. 10, the terminal device 1000 includes a processing unit 1010 and a memory 1020. The processing unit 1010 can be configured to implement instructions that correspond to the terminal device 1000.

It should be understood that the processor in the implementations of this technology may be an integrated circuit chip and has a signal processing capability. During implementation, the steps in the foregoing method may be implemented by using an integrated logic circuit of hardware in the processor or an instruction in the form of software. The processor may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor may be a microprocessor, or the processor may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory, and the processor reads information in the memory and completes the steps in the foregoing methods in combination with the hardware thereof.

It may be understood that the memory in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the term “processor” as generally used herein refers to any data processor. Information handled by the processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The terms “coupled” and “connected,” along with their derivatives, can be used herein to describe structural relationships between components. It should be understood that these terms are not intended as synonyms for each other. Rather, in particular implementations, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements cooperate or interact with each other (e.g., as in a cause-and-effect relationship, such as for signal transmission/reception or for function calls), or both. The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims.

In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

1. A transmitter system for processing a video, comprising:
an object recognition component configured to identify one or more objects in the video and extract one or more features associated with the one or more objects;
a video processing component configured to process each frame of the video by removing the one or more objects;
a video encoding component configured to encode the processed video; and
a transmitting component configured to transmit the encoded video and the extracted features of the one or more objects.

2. The system of claim 1, further comprising:
an object database configured to store reference object information for identifying the one or more objects.

3. The system of claim 1, wherein the one or more objects include at least one of: a traffic sign, a road indicator, information table, company/product/institution logo, or an area or a field that provides textual and/or numerical information.

4. The system of claim 1, wherein the extracted one or more features include at least one of:
a text, a number, a color, a font, a size, or a location associated with the one or more objects.

5. The system of claim 1, wherein the video processing component is configured to replace the one or more objects by a blank in each frame of the video.

6. The system of claim 1, wherein the video processing component is configured to replace the one or more objects by a background color in each frame of the video.

7. The system of claim 1, wherein the video processing component is configured to replace the one or more objects by a background image in each frame of the video.

8. The system of claim 7, wherein the background image is determined based on an image adjacent to the one or more objects.

9. The system of claim 7, wherein the background image is determined based on images surrounding the one or more objects.

10. The system of claim 1, wherein object recognition component is further configured to monitor the one or more objects so as to determine a moving direction of the identified one or more objects.

11. A receiver system for processing a video, comprising:
a receiving component configured to receive an encoded video and one or more extracted features, wherein one or more objects of the encoded video have been removed, and wherein the one or more extracted features are associated with the one or more objects;
a video decoding component configured to decode the encoded video;
an object reconstruction component and configured to generate an image based on the extracted features; and
a video merging component configured to combine the image based on the extracted features with the decoded video.

12. The system of claim 11, further comprising:
an object database configured to store reference object information for identifying the one or more objects.

13. The system of claim 11, wherein the one or more objects include at least one of: a traffic sign, a road indicator, or an area or a field that provides textual and/or numerical information.

14. The system of claim 11, wherein the one or more extracted features include at least one of: a text, a number, a color, a font, a size, or a location associated with the one or more objects.

15. The system of claim 11, wherein the object reconstruction component is configured to generate the image by adding the one or more extracted features to the one or more objects.

16. A method for processing a video, comprising:
identifying one or more objects in the video;
extracting features associated with the identified objects;
processing images corresponding to the identified objects in each frame of the video;
generating descriptors corresponding to the extracted features;
compressing the generated descriptors;
encoding the video with the processed images; and
transmitting the encoded video and the encoded descriptors.

17. The method of claim 16, further comprising:
receiving the encoded video and the compressed descriptors via a network;
decompressing the compressed descriptors; and
decoding the encoded video based on the decompressed descriptors.

18. The method of claim 16, wherein the one or more objects include at least one of: a traffic sign, a road indicator, or an area or a field that provides textual and/or numerical information.

19. The method of claim 16, wherein the one or more extracted features include at least one of: a text, a number, a color, a font, a size, or a location associated with the one or more objects.

20. The method of claim 16, wherein processing the images corresponding to the identified objects in each frame of the video includes:
replacing the one or more objects by a background image in each frame of the video.
